(19) United States
(12) Patent Application Publication
(10) Pub. No.: US 2014/0316808 A1
(43) Pub. Date: Oct. 23, 2014

(54) Cross-Enterprise Electronic Healthcare Document Sharing

(71) Applicant: Lexmark International Technology SA, Geneva (CH)

(72) Inventors: Jeffrey Allen Romatoski, Woodbury, MN (US); Razvan Atanasiu, Minnetrista, MN (US); Otto Hunter Gasser, Birmingham, AL (US)

(73) Assignee: Lexmark International Technology SA, Geneva (CH)

(21) Appl. No.: 13/902,015

(22) Filed: May 24, 2013

Related U.S. Application Data
(60) Provisional application No. 61/814,882, filed on Apr. 23, 2013.

(51) Int. Cl. G06F 19/00

(52) U.S. Cl. CPC G06F 19/321
USPC 705/3

(57) ABSTRACT

A computer system according to one example embodiment includes a web service interface configured to receive a non-DICOM electronic healthcare document and metadata associated with the non-DICOM electronic healthcare document, to convert the electronic healthcare document from an object format of the web service interface to XDS object format, and to submit the converted electronic healthcare document to an electronic repository and the associated metadata to an electronic registry.

### CROSS-REFERENCES TO RELATED APPLICATIONS

This application claims priority to U.S. Provisional Patent Application Ser. No. 61/814,882, filed Apr. 23, 2013, entitled “Cross-Enterprise Electronic Healthcare Document Sharing by Web Services.” the content of which is hereby incorporated by reference in its entirety.

### BACKGROUND

1. Field of the Disclosure

The present disclosure relates generally to health enterprises and more particularly to cross-enterprise electronic healthcare document sharing.

2. Description of the Related Art

A computer network includes a variety of computing devices that communicate and share resources and data. A medical imaging environment, for example, may include a number of networked devices including a medical imaging modality that generates medical images of a patient, a diagnostic view station for displaying the images, an output device for printing the images on film or other media and an archive system for storing the images. These devices are often collectively referred to as a picture archiving and communication system (PACS) and may communicate using a number of protocols. The American College of Radiology and National Electrical Manufacturers Association, for example, developed one such protocol referred to as Digital Imaging and Communications in Medicine (DICOM). In general, DICOM defines vendor-independent data formats and data transfer services for digital medical images.

Cross-Enterprise Document Sharing (XDS) is a technical framework defined by Integrating the Healthcare Enterprise” (IHE) that facilitates the sharing of electronic healthcare documents within and across health enterprises. XDS is based on a generic data model (ebXml 3.0). IHE has defined a set of healthcare specific codes to map XDS to this generic data model. However, the mapping of the data structures of ebXml 3.0 to the semantics of healthcare is not straightforward causing the XDS framework to be complex and difficult for users to manage. Accordingly, an application development tool that simplifies the XDS framework is desired.

### SUMMARY

A computing device according to one example embodiment includes one or more processing devices configured to receive a request to submit a non-DICOM electronic healthcare document to an electronic repository, to associate a preformed metadata template with the electronic healthcare document, and to send the electronic healthcare document and the associated metadata for submission to the electronic repository and an electronic registry, respectively.

A computer system according to another example embodiment includes a web service interface configured to receive a non-DICOM electronic healthcare document and metadata associated with the non-DICOM electronic healthcare document, to convert the electronic healthcare document from an object format of the web service interface to XDS object format, and to submit the converted electronic healthcare document to an electronic repository and the associated metadata to an electronic registry.

### BRIEF DESCRIPTION OF THE DRAWINGS

The accompanying drawings incorporated in and forming a part of the specification, illustrate several aspects of the present disclosure, and together with the description serve to explain the principles of the present disclosure.

FIG. 1 is a block diagram illustrating a system for communication and storage of electronic healthcare documents according to one example embodiment.

FIG. 2 is a block diagram illustrating an example healthcare entity in communication with a web service API for sharing electronic healthcare documents.

FIG. 3 is a flowchart illustrating a method for building a metadata template to classify electronic healthcare documents according to one example embodiment.

FIG. 4 is a flowchart illustrating a method for submitting electronic healthcare documents according to one example embodiment.

FIG. 5 is a flowchart illustrating a method for retrieving electronic healthcare documents according to one example embodiment.

### DETAILED DESCRIPTION

In the following description, reference is made to the accompanying drawings where like numerals represent like elements. The embodiments are described in sufficient detail to enable those skilled in the art to practice the present disclosure. It is to be understood that other embodiments may be utilized and that process, electrical, and mechanical changes, etc., may be made without departing from the scope of the present disclosure. Examples merely typify possible variations. Portions and features of some embodiments may be included in or substituted for those of others. The following description, therefore, is not to be taken in a limiting sense and the scope of the present disclosure is defined only by the appended claims and their equivalents.

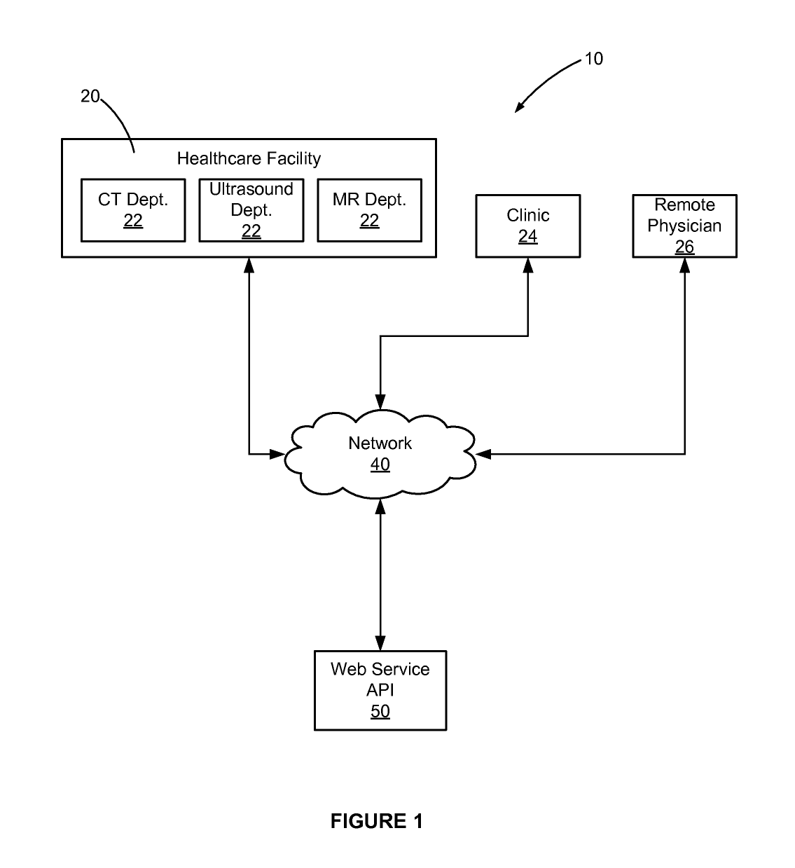

FIG. 1 is a block diagram illustrating a system 10 for communication and storage of electronic healthcare documents according to one example embodiment. System 10 includes various institutions or entities such as, for example, one or more healthcare facilities 20 having a number of departments 22. Each department 22 may include a number of medical imaging devices. Departments 22 may include, for example, medical modalities of different types, such as magnetic resonance (MR), computed tomography (CT), digital radiography (DR), ultrasound (US), positron emission tomography (PET), endoscopy (ES), mammograms (MG), computed radiography (CR), etc. Each medical modality may have different imaging characteristics and features and may generate substantially different patient data and associated medical images. Healthcare facility 20 and departments 22 may also include other computing devices, such as view stations for displaying and annotating medical images and data, an output device for printing medical images and data, a local archive for storing medical images and data and a personal computer for managing medical images and data. System 10 may also include one or more remote clinics 24, which may also include computing devices such as medical imaging devices, view stations, output devices, memory devices or a personal computer. System 10 may also include one or more remote physicians 26 wishing to remotely view or submit medical images and data via a computing device, such as a personal computer, which may include a desktop computer, a laptop computer, tablet computer or smart phone.

The various computing devices of healthcare facility 20, clinics 24 and remote physicians 26 communicate via a network 40 with a web service application programming interface (API) 50 that facilitates the transfer and sharing of electronic healthcare documents across system 10. Network 40 may be a global network such as the Internet, as in the example embodiment illustrated. The computing devices of system 10 may communicate DICOM documents having a file format conforming to the DICOM protocol as well as non-DICOM documents having a file format that does not conform to the DICOM protocol. In this manner, web service API 50 allows medical professionals to perform collaborative studies on images and data, even when the professionals are in different facilities, even across the country.

The computing devices of system 10 each include one or more processors communicatively coupled to a computer readable storage medium having computer executable program instructions which, when executed by the processor(s), cause the processor(s) to perform the steps described herein. The storage medium may include read-only memory (ROM), random access memory (RAM), non-volatile RAM (NVRAM), optical media, magnetic media, semiconductor memory devices, flash memory devices, mass data storage devices (e.g., a hard drive, CD-ROM and/or DVD units) and/or other memory as is known in the art. The processor(s) execute the program instructions to receive and send electronic healthcare documents over network 40. The processor(s) may include one or more general or special purpose microprocessors, or any one or more processors of any kind of digital computer. Alternatives include those wherein all or a portion of the processor(s) is implemented by an application-specific integrated circuit (ASIC) or another dedicated hardware component as is known in the art.

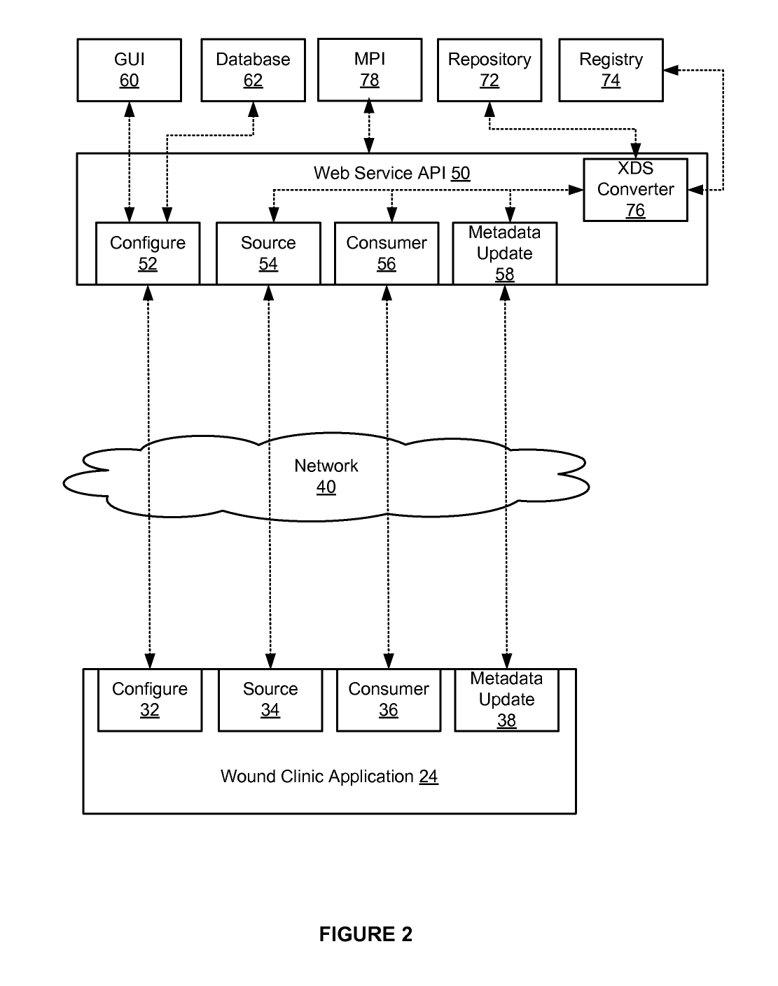

FIG. 2 is a block diagram illustrating the communication between a computing device of an example entity, such as a wound clinic 24, and web service API 50 over network 40. In general, web service API 50 simplifies and accelerates the application development of XDS applications. Web service API 50 may be used to develop applications for a wide range of devices such as, for example, mobile devices, web applications and native applications using any suitable programming language having support for web services. Web service API 50 works with objects (e.g., documents, folders, etc.) in a more user-friendly format than the XDS object format. As discussed in greater detail below, a graphical user interface (GUI) 60 in communication with web service API 50 permits a user to build a valid XDS metadata template for submitting an XDS document, such as an image of a wound, for a particular application. The metadata templates are stored in one or more databases 62. An application running on the computing device(s) of wound clinic 24 includes a configuration interface 32 that communicates with a configuration interface 52 of web service API 50 via network 40 to permit retrieval and configuration of metadata templates stored in database 62. A source interface 34 communicates with a source interface 54 of web service API 50 via network 40 to permit the submission of electronic healthcare documents and their associated metadata to a repository 72 and a registry 74, respectively. As is known in the health enterprises art, the XDS framework dictates that a document repository is responsible for storing documents and responding to document retrieval to requests. A document registry is responsible for storing metadata related to the stored documents to permit identification and retrieval of the documents. Documents are provided to the repositories by a “source” and retrieved by a “consumer.” A consumer interface 36 communicates with a consumer interface 56 of web service API 50 via network 40 to permit the retrieval of electronic healthcare documents from repository 72 based on their associated metadata, stored in registry 74. A metadata update interface 38 communicates with a metadata update interface 58 of web service API 50 via network 40 to permit the modification of the metadata of stored documents.

As mentioned above, web service API 50 permits the user to work with the more user-friendly object format of web service API 50 instead of the more complicated XDS object format. In one embodiment, web service API 50 presents the objects based on the principles of a computer file system in order to expose functionality to the user in semantic terms more familiar to the user. In place of the more complicated XDS object format, the objects of web service API 50 may include documents, folders and submission sets. A document contains electronic healthcare information such as a medical image. Folders store and organize the documents. A submission set is an association of one or more documents and folders based on the author of the submission of the documents and folders to web service API 50. The submitting author may be a person or a machine process and may be different from the author(s) of the document(s) being submitted. Web service API 50 also includes an XDS converter 76 that converts the objects of web service API 50 to the XDS object format and vice versa so that the electronic healthcare documents may be stored according to the XDS framework but submitted and retrieved using the more user-friendly format of web service API 50. Web service API 50 is also in communication with a master patient index (MPI) 78. MPI 78 is a database that maintains consistent, accurate and current bibliographic and medical data on patients seen by the various healthcare entities of system 10.

Web service API 50 permits the construction of metadata templates to classify documents submitted by document sources and to facilitate retrieval of the submitted documents by document consumers based on the metadata associated with the document. The XDS framework defines the metadata fields. A template may define all of the metadata values for a particular author. For example, an author may submit jpeg images produced on a mobile device to a patient's record.

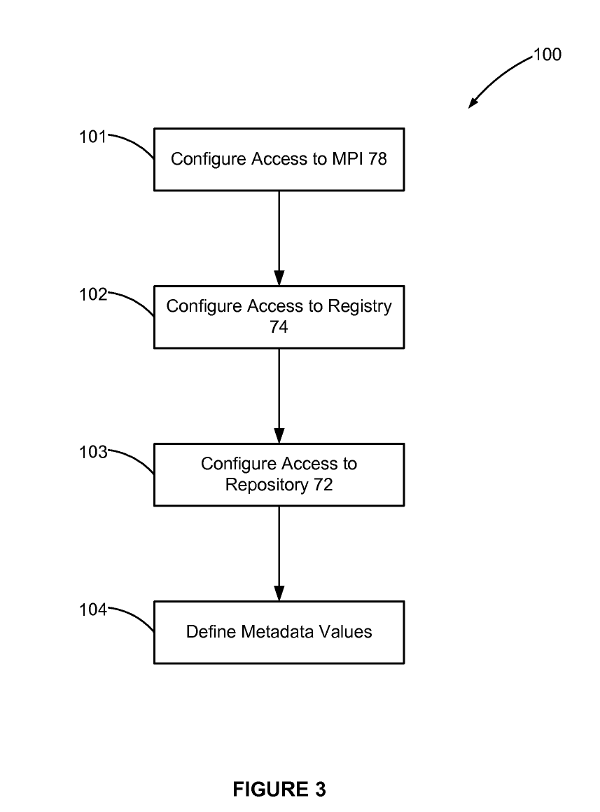

With reference to FIG. 3, a method 100 for building a metadata template to classify electronic healthcare documents is shown according to one example embodiment. The user, through GUI 60, defines the XDS Affinity Domain that web service API 50 will employ for system 10. An XDS Affinity Domain is a group of healthcare entities (e.g., hospitals, clinics, physicians and other healthcare providers, government sponsored facilities, insurance providers, etc.) sharing a common electronic healthcare information infrastructure. Specifically, at step 101, the user configures access to the MPI 78 associated with the desired Affinity Domain. At step 102, the user configures access to the registry 74 associated with the desired Affinity Domain. At step 103, the user configures access to the repository 72 associated with the desired Affinity Domain. Access to repository 72, registry 74 and MPI 78 may be obtained using a standard communications protocol, such as HTTPS. For example, configuring access to repository 72 may include inputting a unique ID of repository 72 and a secure URL to repository 72. The configuration of the access to these databases may be performed in any suitable order.

At step 104, the user, again through GUI 60, defines the metadata values of the metadata template. The defined metadata values include metadata values related to the submission set including information about the author submitting the submission set, such as the following XDS metadata fields:
authorPerson—the human and/or machine submitting the submission set;
authorInstitution—the specific healthcare facility under which the human and/or machine is submitting the submission set (e.g., XYZ Wound Clinic, etc.);
authorRole—the role of the human and/or machine submitting the submission set with respect to the patient (e.g., clinician, etc.);
authorSpecialty—the specialty within the healthcare facility under which the human and/or machine is submitting the submission set (e.g., wound care, cardiology, etc.); and
contentTypeCode—the type of clinical activity that resulted in the submission set (e.g., initial evaluation, etc.).

The defined metadata values also include metadata values related to the document being submitted including information about the author of the document and information about the document, such as the following XDS metadata fields:

authorPerson—the human and/or machine that authored the document;

authorInstitution—the specific healthcare facility under which the human and/or machine authored the document (e.g., XYZ Wound Clinic, etc.);

authorRole—the role of the human and/or machine that authored the document with respect to the patient (e.g., clinician, surgeon, etc.);

authorSpecialty—the specialty within the healthcare facility under which the human and/or machine authored the document (e.g., wound care, cardiology, etc.);

formatCode—the type of the document (e.g., generic image, ultrasound image, etc.);

healthcareFacilityTypeCode—the type of organizational setting of the clinical encounter during which the document act occurred (e.g., wound clinic, etc.);

practiceSettingCode—the clinical specialty where the act that resulted in the document was performed (e.g., general medicine, family practice, radiology, etc.);

classCode—the kind of document (e.g., initial evaluation, prescription, discharge summary, report, etc.);

typeCode—the precise kind of document (e.g., inpatient evaluation and management note, pulmonary history and physical, discharge summary, ultrasound report, etc.);

confidentialityCode—the level of confidentiality of the document; and

eventCodeList—the main clinical acts being documented (e.g., shoulder, colonoscopy, etc.).

Each object type may also include additional metadata fields used to identify the object. For example, a submission set may include the status of the submission set and the time or date the submission set was submitted. A folder may include such fields as the status of the folder, the time the folder was last updated, the name of the folder, the author of the folder and a description of the folder. A document may include such additional fields as the status of the document, the time or date the document was created, the time or date the medical procedure was performed, an identifier of the repository the document is stored in, the size of the document, the programming language of the document and a URI of the document generated by repository 72.

The metadata templates created according to method 100 are stored in database 62. The completed metadata templates provide default metadata values for a given user when the user submits documents as a document source using source interface 34. The completed metadata template also enables routing of the submitted documents and their associated metadata to the proper repository 72 and registry 74, respectively.

In one embodiment, the metadata templates created according to method 100 allow the submission of non-DICOM documents in compliance with the XDS framework. DICOM documents include header tags that contain the metadata values necessary to fill in the metadata fields defined by the XDS framework but non-DICOM documents do not. A metadata template created according to method 100 allows, for example, an author to submit a non-DICOM image, such as a jpeg, pdf, tiff, etc. image, produced on a mobile device, such as a smart phone, in compliance with the XDS framework. The values from the metadata template provide the XDS metadata values missing from such a non-DICOM document.

Web service API 50 uses various data contracts to allow XDS converter 76 to exchange XDS objects with the objects of web service API 50. In one embodiment, each object (e.g., document, folder, submission set, etc.) includes three main identifiers: Entry Uuid, Unique Id and Logical Identifier (LID). The Entry Uuid is a globally unique identifier for each object in XDS. Multiple versions of the same document have unique Entry Uuids. The Unique Id is an object identifier (OID) that defines the object. Multiple versions of the same document will have unique Unique Ids. The LID is the same for all versions of an object allowing a user to query all versions of a document using the LID. In one embodiment, each document has one of three valid statuses: Deprecated, Approved or Submitted. A Submitted document is in the process of being stored and has not yet been Approved. An Approved document has been stored in repository 72. A Deprecated document has been has been stored in repository 72 but marked as not being current (e.g., an older version of a document may have a status of Deprecated and the current version of the document may have a status of Approved). Each object is also associated with a particular patient stored in MPI 78 via a patient ID. Additional metadata fields related to the bibliographic information of the patient and stored in MPI 78 may include, for example, the name of the patient, the birth date of the patient, the sex of the patient and the address of the patient.

With reference back to FIG. 2, configuration interface 32 may be used to retrieve and configure metadata templates stored in database 62, such as metadata templates created according to method 100 discussed above. For example, a user may retrieve valid metadata codes for a configured Affinity Domain by entering the name of the corresponding repository 72 at configuration interface 32. A user may also set up access to a repository 72 configured at step 103 by entering the name of the repository 72 at configuration interface 32. Similarly, a user may set up access to a registry 74 configured at step 102 by entering the name of the corresponding repository 72 at configuration interface 32. A user may also retrieve a metadata template created at step 104 at configuration interface 32.

Example code for utilizing configuration interface 32 according to one embodiment includes:

/// <summary>
/// Returns the Configuration XML for the registry in the Affinity Domain.
This is used
in the consumer interface
/// Web Services Initialize call to associate the consumer with the configured
Registry.
/// </summary>
/// <param name=“repositoryFriendlyName”>The Repository Template name
defined in
the GUI.</param>
/// <returns>The XML Configuration of the Registry associated with the
repository
template.</returns>
[OperationContract]
string GetRegistryAccess(string repositoryFriendlyName);
/// <summary>
/// Returns the Configuration XML for the templated repository in the
Affinity Domain.
/// </summary>
/// <param name=“repositoryFriendlyName”>The Repository Template name
defined in
the GUI.</param>
/// <returns></returns>
[OperationContract]
string GetRepositoryAccess(string repositoryFriendlyName);
/// <summary>
/// Returns the XML String for all the valid Metadata codes in the
Affinity Domain
/// </summary>
/// <param name=“repositoryFriendlyName”>The Repository Template name
defined in
the GUI.</param>
/// <returns></returns>
[OperationContract]
string GetAffinityDomainCodes(string repositoryFriendlyName);
/// <summary>
/// Returns the Submission Set MetaData Template as an XDS Document
Object
/// </summary>
/// <param name=“repositoryFriendlyName”>The Repository Template
name defined in
the GUI.</param>
/// <returns></returns>
[OperationContract]
XdsSubmissionSet GetSubmissionSetMetadataTemplate(string
repositoryFriendlyName);
/// <summary>
/// Returns the Document MetaData Template as an XDS Document Object
/// </summary>
/// <param name=“repositoryFriendlyName”>The Repository Template
name defined in
the GUI.</param>
/// <returns></returns>
[OperationContract]
XdsDocument GetDocumentMetadataTemplate(string
repositoryFriendlyName);

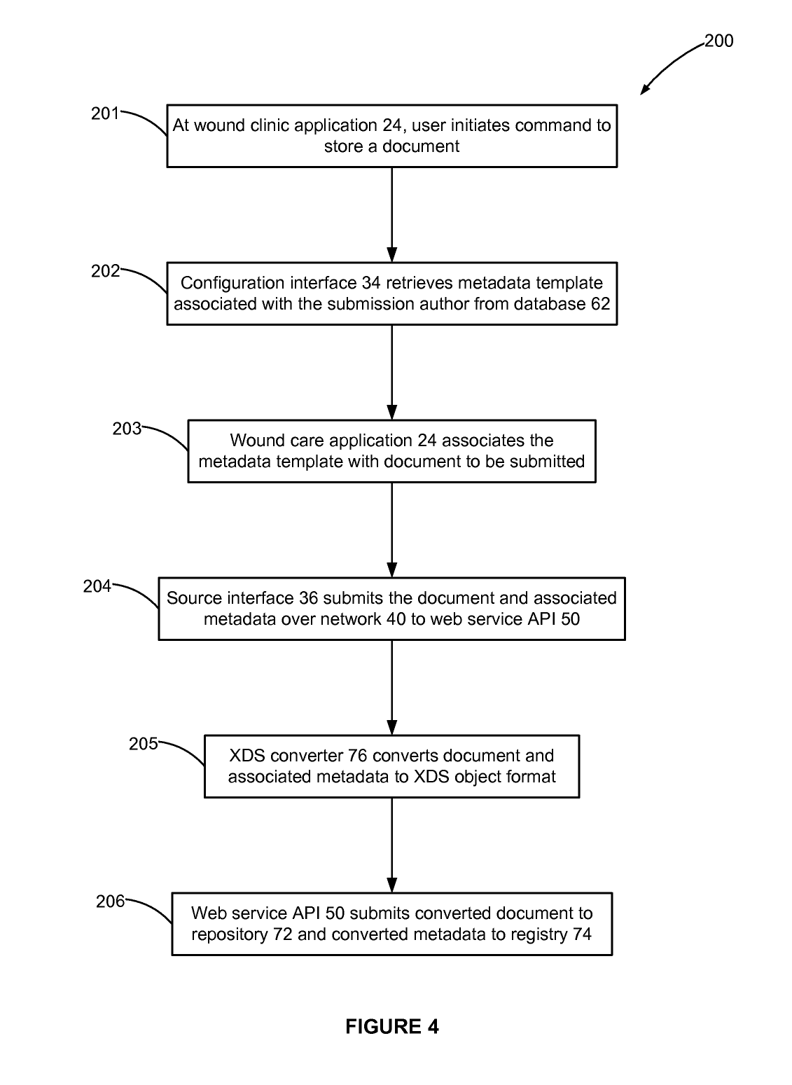

Source interface 34 may be used to submit electronic healthcare documents as a document source. For example, with reference to FIG. 4, a method 200 for submitting electronic healthcare documents is shown according to one example embodiment. At step 201, a user initiates a command to store a document through the computing device of example wound clinic 24. In one embodiment, the command requires the following input parameters: an identification of the submitter, an identification of the document(s) to be submitted and an identification of the patient in MPI 78 the document(s) relate to. The command to store a document may also designate whether the document(s) are to be included in a folder and, if a folder is to be used, whether a new folder or an existing folder will be used. Upon receiving the command to store a document, at step 202, configuration interface 32 retrieves the metadata template associated with the author of the submission from database 62. The metadata template is returned to the computing device of wound clinic 24 in the object format of web service API 50. At step 203, the computing device of wound clinic 24 associates the metadata template with the document to be submitted. As discussed above, the metadata template includes default metadata values for the submission including information about the submission and information about the document being submitted. These default values may be edited by the user prior to submitting the document. At step 204, source interface 34 submits the document and the metadata template over network 40 to source interface 54 of web service API 50. The document and the associated metadata are submitted in the object format of web service API 50. At step 205, XDS converter 76 converts the document and the associated metadata to XDS object format. At step 206, web service API 50 submits the converted document to repository 72 and the converted metadata to registry 74. The submitted document may then be retrieved from repository 72 by a document consumer according to its associated metadata stored in registry 74 as discussed in greater detail below.

In one embodiment, web service API 50 also permits a user to submit a document asynchronously as desired. In this embodiment, a user initiates a command to store a document through the computing device of example wound clinic 24 as discussed above with respect to method 200. Where the user chooses to submit the document asynchronously, a call back URL may be provided that allows the user to obtain the status of the document submission request. For example, after the asynchronous document submission command is entered, the user, at the computing device of wound clinic 24 or another computing device of system 10, may request the status of the document submission by entering the call back URL. Example submission statuses include: Error (an error occurred in the submission), Waiting (the submission is scheduled but has not yet started), Retry (an error occurred in the submission requiring another submission attempt), Completed (the submission is complete), Paused (the submission is paused), Canceled (the submission has been canceled). A user may also use the call back URL at the computing device of wound clinic 24 or another computing device of system 10 to cancel a previously entered asynchronous document submission command.

As discussed above, folders may be used to store and organize the stored documents. A user may initiate a command to create a folder through the computing device of example wound clinic 24. In one embodiment, the command requires the following input parameters: an identification of the author creating the folder, an identification of the patient in MPI 78 related to the folder and any metadata values associated with a folder (e.g., folder name, folder description, folder author, etc.). In one embodiment, upon receiving the command to create a folder, configuration interface 32 retrieves the metadata template associated with the author of the submission from database 62 in order to provide default values for the metadata fields associated with information about the submission. Source interface 34 submits the folder and the associated metadata over network 40 to source interface 54 of web service API 50 in the object format of web service API 50. As discussed above, XDS converter 76 converts the folder and the associated metadata to XDS object format. Web service API 50 submits the folder to repository 72 and the converted metadata to registry 74 where the created folder may be associated with documents stored in repository 72 to simplify retrieval of the documents by a document consumer.

In one embodiment, web service API 50 also permits a user to replace a document as desired. In one embodiment, the command to replace a document requires the following input parameters: an identification of the submitter, an identification of the document to be replaced, an identification of the replacement document and an identification of the patient in MPI 78 the documents relate to. Upon receiving the command to replace a document, configuration interface 32 retrieves the metadata template associated with the author of the submission from database 62 in the object format of web service API 50 as discussed above. The computing device of wound clinic 24 then associates the metadata template, which may be edited prior to submitting the replacement document, with the replacement document including information about the submission and information about the replacement document. Source interface 34 then submits the replacement document, the metadata template associated with the replacement document and a command to deprecate the document to be replaced over network 40 to source interface 54 of web service API 50. The replacement document and its associated metadata are submitted in the object format of web service API 50. XDS converter 76 converts the replacement document and the associated metadata to XDS object format. Web service API 50 submits the converted replacement document to repository 72 as a newer version of the document being replaced and the converted metadata to registry 74. Web service API 50 also modifies the metadata associated with the document being replaced to change its status from Approved to Deprecated.

Web service API 50 may also permit a user to append a document, such as, for example, adding a thumbnail image to the document, as desired. In one embodiment, the command to append a document requires the following input parameters: an identification of the submitter, an identification of the document being appended, an identification of the appended document and an identification of the patient in MPI 78 the document relates to. Upon receiving the command to append a document, configuration interface 32 retrieves the metadata template associated with the author of the submission from database 62 in the object format of web service API 50 as discussed above. The computing device of wound clinic 24 then associates the metadata template, which, again, may be edited prior to submitting the appended document, with the appended document including information about the submission and information about the appended document. Source interface 34 then submits the appended document and the metadata template associated with the appended document over network 40 to source interface 54. The appended document and its associated metadata are submitted in the object format of web service API 50. XDS converter 76 converts the appended document and the associated metadata to XDS object format. Web service API 50 submits the converted appended document to repository 72 as an appendix of the document being appended and the converted metadata to registry 74.

Example code for utilizing source interface 34 according to one embodiment includes:

// Store Documents to the Repository. The Documents can be associated
with a new or
existing Folder.
[OperationContract]
void StoreDocuments(XdsTransactionIdentifier xdsTransactionIdentifier,
XdsLocalPatientIdentifier localPatientIdentifier, XdsSubmissionSet
xdsSubmissionSet,
StoreDocumentFolderSettings folderParameters,
StoreDocumentDocumentSettings[ ]
documents);
// Store Documents Asynchronously to the Repository. An optional
callback URL can be
provided to get notification of completion.
[OperationContract]
int StoreDocumentsAsync(XdsTransactionIdentifier
xdsTransactionIdentifier,
XdsLocalPatientIdentifier localPatientIdentifier, XdsSubmissionSet
xdsSubmissionSet,
StoreDocumentFolderSettings folderSettings,
StoreDocumentDocumentSettings[ ]
documentSettings, string callBackUrl);
// Cancel an Asynchronous StoreDocuments Request. The input
parameter is the output
of the StoreDocumentsAsync request.
[OperationContract]
StoreDocumentsCancelStatus CancelStoreDocuments(int storeId);
// Get the status of a StoreDocuments Request. The input parameter
is the output of the
StoreDocumentsAsync request.
[OperationContract]
StoreDocumentsStatus GetStoreDocumentsStatus(int storeId);
// Create a Folder within the Registry.
[OperationContract]
void CreateFolder(XdsTransactionIdentifier xdsTransactionIdentifier,
XdsLocalPatientIdentifier localPatientIdentifier, XdsSubmissionSet
xdsSubmissionSet,
XdsFolder xdsFolder);
// Replace a Document.
[OperationContract]
void ReplaceDocument(XdsTransactionIdentifier xdsTransactionIdentifier,
XdsLocalPatientIdentifier localPatientIdentifier, XdsSubmissionSet
xdsSubmissionSet,
XdsDocument oldDocument, StoreDocumentDocumentSettings
newDocument);
// Append a Document with a Document.
[OperationContract]
void AppendDocument(XdsTransactionIdentifier xdsTransactionIdentifier,
XdsLocalPatientIdentifier localPatientIdentifier, XdsSubmissionSet
xdsSubmissionSet,
XdsDocument theDocument, StoreDocumentDocumentSettings
appendDocument);
// Add a transformation to an existing Document. One Use Case is
to associate a
thumbnail with an image document.
[OperationContract]
void AddTransformDocument(XdsTransactionIdentifier
xdsTransactionIdentifier,
XdsLocalPatientIdentifier localPatientIdentifier, XdsSubmissionSet
xdsSubmissionSet,
XdsDocument theDocument, StoreDocumentDocumentSettings
transformDocument);

For example, the code required at source interface 34 of an application running on the computing device(s) of wound clinic 24 to submit a document to an existing folder may include:

// Set up the Transaction Identifier
ServiceReferenceXds.XdsTransactionIdentifier xdsTransactionIdentifier =
new ServiceR
eferenceXds.XdsTransactionIdentifier( );
xdsTransactionIdentifier.UserSignature = “Acuo StoreDocuments
Test Program”;
xdsTransactionIdentifier.UserTransactionId = 0;
xdsTransactionIdentifier.GroupId = “”;
xdsTransactionIdentifier.RepositoryFriendlyName =
comboBoxRepositoryName.Selecte
dValue.ToString( );
// Provide the local Patient Id
ServiceReferenceXds.XdsLocalPatientIdentifier localPatientIdentifier =
new ServiceRefe
renceXds.XdsLocalPatientIdentifier( );
localPatientIdentifier.Id = xdsSubSetMetaData.textBoxLocalPatientId.Text;
localPatientIdentifier.DomainName =
xdsSubSetMetaData.textBoxLocalDomainName.T
ext;
localPatientIdentifier.DomainId =
xdsSubSetMetaData.textBoxLocalDomainId.Text;
localPatientIdentifier.DomainAssigningAuthority =
xdsSubSetMetaData.textBoxLocalD
omainAuthority.Text;
// Provide the XDS Submission Set
ServiceReferenceXds.XdsSubmissionSet xdsSubmissionSet =
xdsSubSetMetaData.GetS
ubmissionSet(oidRoot);
// Provide the Folder Relationship, if any
ServiceReferenceXds.StoreDocumentFolderSettings folderParameters =
GetFolderParam
eters( );
// Set up the document
int ndx = 0;
ServiceReferenceXds.StoreDocumentDocumentSettings[ ] documents =
new ServiceRefe
renceXds.StoreDocumentDocumentSettings[DocumentTabs.Items.Count];
foreach (TabItem item in DocumentTabs.Items)
{
XdsDocument document = (XdsDocument)item.Content;
ServiceReferenceXds.StoreDocumentDocumentSettings
storeDocumentDocumentSetting
s = new ServiceReferenceXds.StoreDocumentDocumentSettings( );
documents [ndx++] = storeDocumentDocumentSettings;
storeDocumentDocumentSettings.StoreDocumentSource =
new ServiceReferenceXds.St
oreDocumentDocumentSource( );
if (document.comboBoxContentType.Text == “”)
{
storeDocumentDocumentSettings.StoreDocumentSource.ContentType =
ServiceReferenc
eXds.DocumentContent.xml;
}
else
{
storeDocumentDocumentSettings.StoreDocumentSource.ContentType =
(ServiceReferenceXds.DocumentContent)Enum.
Parse(typeof(ServiceReferenceXds.Doc
umentContent), document.comboBoxContentType.Text);
}
storeDocumentDocumentSettings.StoreDocumentSource.ContentFileName =
document.
ContentFileName;
storeDocumentDocumentSettings.XdsDocument =
document.GetXdsDocument(oidRoot)
;
// Call the Web Service
clientSource = new ServiceReferenceXds.SourceClient( );
clientSource.StoreDocuments(xdsTransactionIdentifier,
localPatientIdentifier, xdsSubmis
sionSet, folderParameters, documents);

In this example, a transaction identifier is provided for traceability of the document submission and the local patient ID is provided to identify the patient the submitted document relates to. Instead of requiring the user to build the ebXml code, configuration interface 32 retrieves the metadata templates associated with the submission set and the document and source interface 34 submits the document along with the associated metadata to web service API 50. As discussed above, source interface 34 then submits the document and the metadata template over network 40 to source interface 54 of web service API 50. XDS converter 76 converts the document to XDS object format and web service API 50 submits the converted document to repository 72. For example, the ebXml code outputted from XDS converter 76 in this example document submission to an existing folder may include:

```
- <SubmitObjectsRequest
xmlns:rs=“urn:oasis:names:tc:ebxml-regrep:xsd:rs:3.0”
xmlns:rim=“urn:oasis:names:tc:ebxml-regrep:xsd:rim:3.0”
xmlns=“urn:oasis:names:tc:ebxml-regrep:xsd:lcm:3.0”>
- <rim:RegistryObjectList>
- <rim:RegistryPackage
id=“urn:uuid:5199e5f4-bda4-4836-8fce-05b29e70b713”>
- <rim:Slot name=“submissionTime”>
- <rim:ValueList>
  <rim:Value>20120413150409</rim:Value>
  </rim:ValueList>
  </rim:Slot>
- <rim:Slot name=“urn:SubmissionSetSlot1”>
- <rim:ValueList>
  <rim:Value>Slot1 Value1</rim:Value>
  </rim:ValueList>
  </rim:Slot>
- <rim:Slot name=“urn:SubmissionSetSlot2”>
- <rim:ValueList>
  <rim:Value>Slot2 Value1</rim:Value>
  <rim:Value>Slot2 Value2</rim:Value>
  </rim:ValueList>
  </rim:Slot>
- <rim:Name>
  <rim:LocalizedString value=“PSW Submission Set Name” />
  </rim:Name>
- <rim:Description>
  <rim:LocalizedString value=“PSW Submission Set Description” />
  </rim:Description>
  <rim:VersionInfo />
- <rim:Classification id=“urn:uuid:3b9ee890-718e-4173-8660-93ed095d1112”
nodeRepresentation=“” classifiedObject=“urn:uuid:5199e5f4-bda4-4836-8fce-05b29e70b713”
classificationScheme=“urn:uuid:a7058bb9-b4e4-4307-ba5b-e3f0ab85e12d”>
- <rim:Slot name=“authorPerson”>
- <rim:ValueList>
  <rim:Value>PSW Submission Set Test Person</rim:Value>
  </rim:ValueList>
  </rim:Slot>
- <rim:Slot name=“authorRole”>
- <rim:ValueList>
  <rim:Value>PSW Submission Set Test Role</rim:Value>
  </rim:ValueList>
  </rim:Slot>
- <rim:Slot name=“authorSpecialty”>
- <rim:ValueList>
  <rim:Value>PSW Submission Set Test Speciality</rim:Value>
  </rim:ValueList>
  </rim: Slot>
- <rim:Slot name=“authorInstitution”>
- <rim:ValueList>
  <rim:Value>PSW Submission Set Test Institution</rim:Value>
  </rim:ValueList>
  </rim: Slot>
  </rim:Classification>
- <rim:Classification id=“urn:uuid:4fe039b3-2771-424f-98e1-a259e0013286”
nodeRepresentation=“ENT” classifiedObject=“urn:uuid:5199e5f4-bda4-4836-8fce-
05b29e70b713” classificationScheme=“urn:uuid:aa543740-bdda-424e-8c96-df4873be8500”>
- <rim:Slot name=“codingScheme”>
- <rim:ValueList>
  <rim:Value>PSW contentTypeCodes</rim:Value>
  </rim:ValueList>
  </rim:Slot>
- <rim:Name>
  <rim:LocalizedString value=“Ear, Nose and Throat (ENT) Documents” />
  </rim:Name>
  </rim:Classification>
- <rim:ExternalIdentifier id=“urn:uuid:e862a538-eb3c-46b5-8ba5-9bb67928a8f3”
registryObject=“urn:uuid:5199e5f4-bda4-4836-8fce-05b29e70b713”
value=“1.2.840.114158.345051510778.7596.20120413100343.1”
identificationScheme=“urn:uuid:96fdda7c-d067-4183-912e-bf5ee74998a8”>
- <rim:Name>
  <rim:LocalizedString value=“XDSSubmissionSet.uniqueId” />
  </rim:Name>
  </rim:ExternalIdentifier>
- <rim:ExternalIdentifier id=“urn:uuid:83bdfba8-8b84-435c-a23f-07e267d4003f”
registryObject=“urn:uuid:5199e5f4-bda4-4836-8fce-05b29e70b713”
value=“1.3.6.1.4.1.21367.2009.5.1.100” identificationScheme=“urn:uuid:554ac39e-e3fe-47fe-
b233-965d2a147832”>
- <rim:Name>
  <rim:LocalizedString value=“XDSSubmissionSet.sourceId” />
  </rim:Name>
  </rim:ExternalIdentifier>
- <rim:ExternalIdentifier id=“urn:uuid:f6aab734-4984-422e-aa9f-5536c022879d”
registryObject=“urn:uuid:5199e5f4-bda4-4836-8fce-05b29e70b713”
value=“53997 \hat{ }\hat{ }\hat{ } &1.3.6.1.4.1.21367.2009.5.1.100&ISO”
identificationScheme=“urn:uuid:6b5aeala-874d-4603-a4bc-96a0a7b38446”>
- <rim:Name>
  <rim:LocalizedString value=“XDSSubmissionSet.patientId” />
  </rim:Name>
  </rim:ExternalIdentifier>
  </rim:RegistryPackage>
- <rim:ExtrinsicObject mimeType=“application/pdf” objectType=“urn:uuid:7edca82f-054d-
47f2-a032-9b2a5b5186c1” id=“urn:uuid:3d532363-7a11-4865-9352-9941534b75a9”>
  <rim:VersionInfo />
- <rim:Slot name=“languageCode”>
- <rim:ValueList>
  <rim:Value>en-us</rim:Value>
  </rim:ValueList>
  </rim: Slot>
- <rim:Slot name=“urn:DocumentSlot1”>
- <rim:ValueList>
  <rim:Value>Slot1 Value1</rim:Value>
  </rim:ValueList>
  </rim:Slot>
- <rim:Slot name=“urn:DocumentSlot2”>
- <rim:ValueList>
  <rim:Value>Slot2 Value1</rim:Value>
  <rim:Value>Slot2 Value2</rim:Value>
  </rim:ValueList>
  </rim:Slot>
- <rim:Slot name=“sourcePatientInfo”>
- <rim:ValueList>
  <rim:Value>PID-3|53997\hat{ }\hat{ }\hat{ }&1.3.6.1.4.1.21367.2009.5.1.100&ISO</rim:Value>
  <rim:Value>PID-5|PSWA\hat{ }TEST_PN_1\hat{ }\hat{ }\hat{ }<rim:Value>
  <rim:Value>PID-7|19601201</rim:Value>
  <rim:Value>PID-8|M</rim:Value>
  </rim:ValueList>
  </rim:Slot>
- <rim:Slot name=“sourcePatientId”>
- <rim:ValueList>
  <rim:Value>53997\hat{ }\hat{ }\hat{ }&1.3.6.1.4.1.21367.2009.5.1.100&ISO</rim:Value>
  </rim:ValueList>
  </rim:Slot>
- <rim:Slot name=“creationTime”>
- <rim:ValueList>
  <rim:Value>20120413100043</rim:Value>
  </rim:ValueList>
  </rim:Slot>
- <rim:Slot name=“serviceStartTime”>
- <rim:ValueList>
  <rim:Value>20120413100043</rim:Value>
  </rim:ValueList>
  </rim:Slot>
- <rim:Slot name=“serviceStopTime”>
- <rim:ValueList>
  <rim:Value>20120413100043</rim:Value>
  </rim:ValueList>
  </rim:Slot>
- <rim:Name>
  <rim:LocalizedString value=“PSW Document1 Name” />
  </rim:Name>
- <rim:Description>
  <rim:LocalizedString value=“PSW Document1 Description” />
  </rim:Description>
- <rim:Classification id=“urn:uuid:e869156c-d0d0-4fa4-9b16-71430abddd40”
nodeRepresentation=“” classifiedObject=“urn:uuid:3d532363-7a11-4865-9352-
9941534b75a9” classificationScheme=“urn:uuid:93606bcf-9494-43ec-9b4e-a7748d1a838d”>
- <rim:Slot name=“authorPerson”>
- <rim:ValueList>
  <rim:Value>PSW Document1 Test Person</rim:Value>
  </rim:ValueList>
  </rim: Slot>
- <rim:Slot name=“authorRole”>
- <rim:ValueList>
  <rim:Value>PSW Document1 Test Role</rim:Value>
  </rim:ValueList>
  </rim:Slot>
- <rim:Slot name=“authorSpecialty”>
- <rim:ValueList>
  <rim:Value>PSW Document1 Test Speciality</rim:Value>
  </rim:ValueList>
  </rim:Slot>
- <rim:Slot name=“authorInstitution”>
- <rim:ValueList>
  <rim:Value>PSW Document1 Test Institution</rim:Value>
  </rim:ValueList>
  </rim:Slot>
  </rim:Classification>
- <rim:Classification id=“urn:uuid:bdb32a3a-0ee5-48db-bbf1-38cb987a6b96”
nodeRepresentation=“ENT” classifiedObject=“urn:uuid:3d532363-7a11-4865-9352-
9941534b75a9” classificationScheme=“urn:uuid:41a5887f-8865-4c09-adf7-e362475b143a”>
- <rim:Slot name=“codingScheme”>
- <rim:ValueList>
  <rim:Value>PSW classCodes</rim:Value>
  </rim:ValueList>
  </rim:Slot>
- <rim:Name>
  <rim:LocalizedString value=“Ear, Nose and Throat (ENT) Documents” />
  </rim:Name>
  </rim:Classification>
- <rim:Classification id=“urn:uuid:49fe2c4b-9992-4920-a659-012d5aab0ca3”
nodeRepresentation=“N” classifiedObject=“”urn:uuid:3d532363-7a11-4865-9352-
9941534b75a9” classificationScheme=“urn:uuid:f4f85eac-e6cb-4883-b52442705394840f”>
- <rim:Slot name=“codingScheme”>
- <rim:ValueList>
  <rim:Value>PSW confidentialityCodes</rim:Value>
  </rim:ValueList>
  </rim:Slot>
- <rim:Name>
  <rim:LocalizedString value=“Normal” />
  </rim:Name>
  </rim:Classification>
- <rim:Classification id=“urn:uuid:b70b6425-f71a-40ac-85db-64b52c09261a”
nodeRepresentation=“ENT” classifiedObject=“urn:uuid:3d532363-7a11-4865-9352-
9941534b75a9” classificationScheme=“urn:uuid:f0306f51-975f-434e-a61c-c59651d33983”>
- <rim:Slot name=“codingScheme”>
- <rim:ValueList>
  <rim:Value>PSW typeCode</rim:Value>
  </rim:ValueList>
  </rim:Slot>
- <rim:Name>
  <rim:LocalizedString value=“Ear, Nose and Throat (ENT) Documents” />
  </rim:Name>
  </rim:Classification>
- <rim:Classification id=“urn:uuid:8e4afc2a-c278-455e-8cf4-5ef590dcd0d8”
nodeRepresentation=“V” classifiedObject=“urn:uuid:3d532363-7a11-4865-9352-
9941534b75a9” classificationScheme=“urn:uuid:a09d5840-386c-46f2-b5ad-9c3699a4309d”>
- <rim:Slot name=“codingScheme”>
- <rim:ValueList>
  <rim:Value>PSW formatCodes</rim:Value>
  </rim:ValueList>
  </rim:Slot>
- <rim:Name>
  <rim:LocalizedString value=“Video” />
  </rim:Name>
  </rim:Classification>
- <rim:Classification id=“urn:uuid:f2d009a3-0925-4280-b4c5-ff05e27a06a2”
nodeRepresentation=“HOSP” classifiedObject=“urn:uuid:3d532363-7a11-4865-9352-
9941534b75a9” classificationScheme=“urn:uuid:f33fb8ac-18af-42cc-ae0e-ed0b0bdb91e1”>
- <rim:Slot name=“codingScheme”>
- <rim:ValueList>
  <rim:Value>PSW healthcareFacilityTypeCodes</rim:Value>
  </rim:ValueList>
  </rim:Slot>
- <rim:Name>
  <rim:LocalizedString value=“Hospital” />
  </rim:Name>
  </rim:Classification>
- <rim:Classification id=“urn:uuid:1d79716e-f195-4411-b839-6e866e655511”
nodeRepresentation=“General Medicine” classifiedObject=“urn:uuid:3d532363-7a11-4865-
9352-9941534b75a9” classificationScheme=“urn:uuid:cccf5598-8b07-4b77-a05e-
ae952c785ead”>
- <rim:Slot name=“codingScheme”>
- <rim:ValueList>
  <rim:Value>PSW practiceSettingCodes</rim:Value>
  </rim:ValueList>
  </rim:Slot>
- <rim:Name>
  <rim:LocalizedString value=“General Medicine” />
  </rim:Name>
  </rim:Classification>
- <rim:ExtemalIdentifier id=“urn:uuid:9be56394-9468-49af-be6d-75bb1a6e241e”
registryObject=“urn:uuid:3d532363-7a11-4865-9352-9941534b75a9”
value=“1.2.840.114158.345051510778.7596.20120413100343.2”
identificationScheme=“urn: uuid:2e82c1f6-a085-4c72-9da3-8640a32e42ab”>
- <rim:Name>
  <rim:LocalizedString value=“XDSDocumentEntry.uniqueId” />
  </rim:Name>
  </rim:ExternalIdentifier>
- <rim:ExtemalIdentifier id=“urn:uuid:331b0170-d0f4-4097-a3d3-d324a6a472dc”
registryObject=“urn:uuid:3d532363-7a11-4865-9352-9941534b75a9”
value=“53997”\hat{ }\hat{ }\hat{ }&1.3.6.1.4.1.21367.2009.5.1.100&ISO”
identificationScheme=“urn:uuid: 58a6f841-87b3-4a3e-92fd-a8ffeff98427”>
- <rim:Name>
  <rim:LocalizedString value=“XDSDocumentEntry.patientId” />
  </rim:Name>
  </rim:ExternalIdentifier>
  </rim:ExtrinsicObject>
  <rim:Classification id=“urn:uuid:c3cf012a-f8cb-41b6-9552-47c3ad51245d”
classifiedObject=“urn:uuid:5199e5f4-bda4-4836-8fce-05b29e70b713”
classificationNode=“urn:uuid:a54d6aa5-d40d-43f9-88c5-b4633d873bdd” />
- <rim:Association id=“urn:uuid:b4cd61a9-ecc6-43d5-b95c-ab7e9b5d14ff”
sourceObject=“urn:uuid:5199e5f4-bda4-4836-8fce-05b29e70b713”
targetObject=“urn:uuid:b3000d27-0653-42ea-b5cd-95f86c0e57f9”
associationType=“urn:oasis:names:tc:ebxml-regrep:AssociationType:HasMember>
- <rim:Slot name=“SubmissionSetStatus”>
- <rim:ValueList>
  <rim:Value>Reference</rim:Value>
  </rim:ValueList>
  </rim:Slot>
  </rim:Association>
- <rim:Association id=“urn:uuid:bd0e95ed-d157-4506-99ad-6bbc8b1ccc41”
sourceObject=“urn:uuid:5199e5f4-bda4-4836-8fce-05b29e70b713”
targetObject=“urn:uuid:3d532363-7a11-4865-9352-9941534b75a9”
associationType=“urn:oasis: names:tc:ebxml-regrep:AssociationType:HasMember>
- <rim:Slot name=“SubmissionSetStatus”>
- <rim:ValueList>
  <rim:Value>Original</rim:Value>
  </rim:ValueList>
  </rim:Slot>
  </rim:Association>
  <rim:Association id=“urn:uuid:1f69d4f6-3f85-4c7f-9b0b-8cea487771b1”
sou rceObject=“urn:uuid:b3000d27-0653-42ea-b5cd-95f86c0e57f9”
targetObject=“urn:uuid:3d532363-7a11-4865-9352-9941534b75a9”
associationType=“urn:oasis:names:tc:ebxml-regrep:AssociationType:HasMember” />
  <rim:Association id=“urn:uuid:c8e8fe7e-588d-4f6d-b431-38eae89e9852”
sourceObject=“urn:uuid:5199e5f4-bda4-4836-8fce-05b29e70b713”
targetObject=“urn:uuid:1f69d4f6-3f85-4c7f-9b0b-8cea487771b1”
associationType=“urn:oasis:names:tc:ebxml-regrep:AssociationType:HasMember” />
  <rim:ObjectRef id=“urn:uuid:a54d6aa5-d40d-43f9-88c5-b4633d873bdd” />
  <rim:ObjectRef id=“urn:uuid:aa543740-bdda-424e-8c96-df4873be8500” />
  <rim:ObjectRef id=“urn:uuid:554ac39e-e3fe-47fe-b233-965d2a147832” />
  <rim:ObjectRef id=“urn:uuid:96fdda7c-d067-4183-912e-bf5ee74998a8” />
  <rim:ObjectRef id=“urn:uuid:6b5aea1a-874d-4603-a4bc-96a0a7b38446” />
  <rim:ObjectRef id=“urn:uuid:7edca82f-054d-47f2-a032-9b2a5b5186c1” />
  <rim:ObjectRef id=“urn:uuid:41a5887f-8865-4c09-adf7-e362475b143a” />
  <rim:ObjectRef id=“urn:uuid:f4f85eac-e6cb-4883-b524-f2705394840f' />
  <rim:ObjectRef id=“urn:uuid:2c6b8cb7-8b2a-4051-b291-b1ae6a575ef4” />
  <rim:ObjectRef id=“urn:uuid:a09d5840-386c-46f2-b5ad-9c3699a4309d” />
  <rim:ObjectRef id=“urn:uuid:f33fb8ac-18af-42cc-ae0e-ed0b0bdb91e1” />
  <rim:ObjectRef id=“urn:uuid:cccf5598-8b07-4b77-a05e-ae952c785ead” />
  <rim:ObjectRef id=“urn:uuid:f0306f51-975f-434e-a61c-c59651d33983” />
  <rim:ObjectRef id=“urn:uuid:2e82c1f6-a085-4c72-9da3-8640a32e42ab” />
  <rim:ObjectRef id=“urn:uuid:58a6f841-87b3-4a3e-92fd-a8ffeff98427” />
  <rim:ObjectRef id=“urn:uuid:93606bcf-9494-43ec-9b4e-a7748d1a838d” />
  <rim:ObjectRef id=“urn:uuid:a7058bb9-b4e4-4307-ba5b-e3f0ab85e12d” />
  </rim:RegistryObjectList>
  </SubmitObjectsRequest>
```

In this example, the “RegistryPackage” is the metadata associated with the submission set and the “ExtrinsicObject” is the metadata associated with the document. The associations link the objects together.

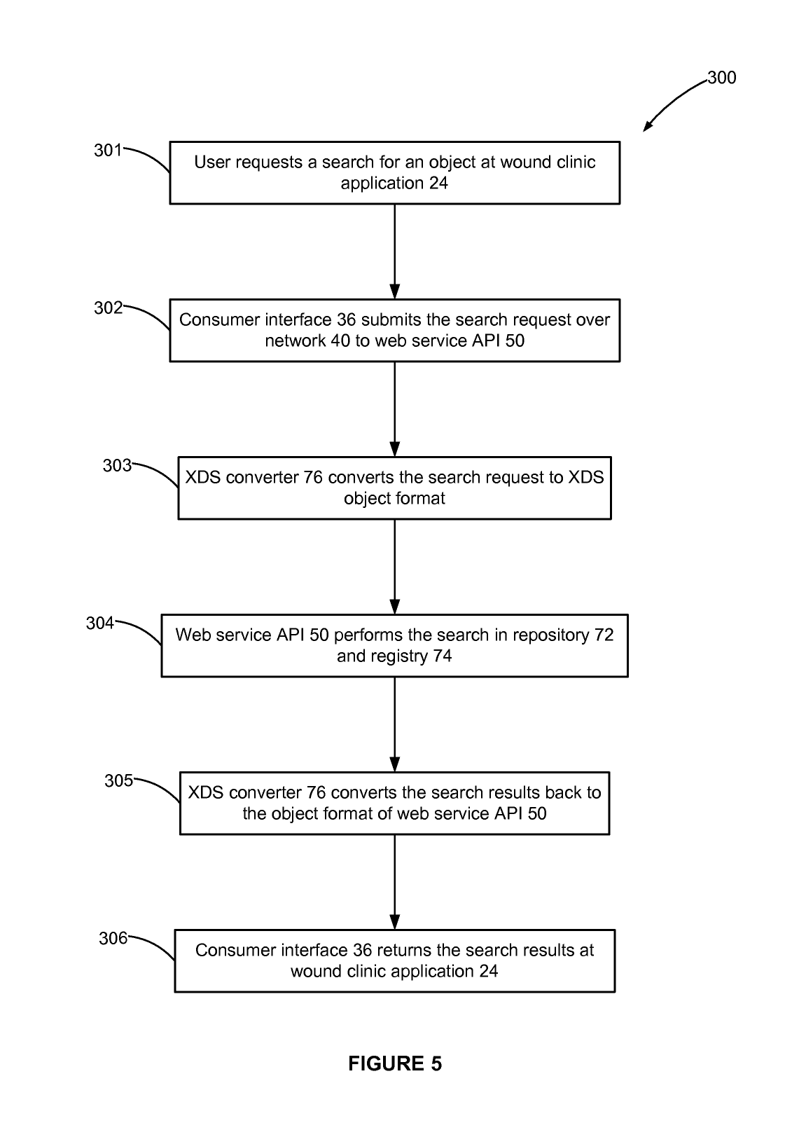

Consumer interface 36 may be used to retrieve electronic healthcare documents from repository 72 as a document consumer. For example, with reference to FIG. 5, a method 300 for retrieving electronic healthcare documents is shown according to one example embodiment. At step 301, a user requests, through the computing device of example wound clinic 24, a search for an object, such as a document, folder or submission set, stored in repository 72. Documents, folders and submission sets may be searched according to a number of parameters and filters as discussed in greater detail below. Upon receiving the search request, at step 302, consumer interface 36 submits the search request over network 40 to web service API 50. The search request is transmitted from consumer interface 36 in the object format of web service API 50. At step 303, XDS converter 76 converts the search request to XDS object format. At step 304, web service API 50 performs the search in repository 72 according to the associated metadata stored in registry 74. At step 305, XDS converter 76 converts the search results back to the object format of web service API 50 so that they may be viewed by the user in a more user-friendly format. At step 306, consumer interface 36 returns the search results at the computing device of wound clinic 24.

As mentioned above, in multiple embodiments, consumer interface 36 and web service API 50 permit the searching of objects according to a variety of parameters and filters. For example, a user may search for a particular type of object, i.e., documents, folders, submission sets or any combination thereof. As desired, a user may search for an object by any of its three main identifiers: Entry Uuid, Unique Id or LID. A user may choose to submit a request to return a list of references to the search result objects (a “find” request) or a request to return the actual objects (a “get” request). A user may search for objects related to a single specified patient, multiple patients or all patients in MPI 78. Document searches may be filtered by, for example, document name, document status, document type, document format, document author, submitting author, the date or time the document was created, submitted or last updated, the date or time the medical procedure leading to the creation of the document was performed, the healthcare institution or type of healthcare institution under which the document was authored or submitted, the type of clinical activity that resulted in the document, the confidentiality of the document or any other suitable metadata field. Further, a user may search for documents related to a specified document, e.g., other versions of the specified document or appendices to the specified document. A user may also search for all documents associated with a specified folder or a specified submission set. Similarly, folder searches may be filtered by, for example, the name of the folder, the status of the folder, folder author, submitting author, the date or time the folder was created, submitted or last updated, a description of the folder or any other suitable metadata field. Further, a user may search for a folder associated with a specified document or a specified submission set. Likewise, submission set searches may be filtered by any suitable metadata value and a user may search for a submission set associated with a specified document or a specified folder.

Example code for utilizing consumer interface 36 according to one embodiment includes:

// Get the Submission Sets for a Document/Folder.
[OperationContract]
XdsSubmissionSet[ ] GetSubmissionSets(XdsTransactionIdentifier
xdsTransactionIdentifier, XdsDocument theDocument, XdsFolder
theFolder);
// Find all the Document references for a patient. Query options
can be supplied.
[OperationContract]
XdsObjectEntryUuid[ ] FindDocuments(XdsTransactionIdentifier
xdsTransactionIdentifier, XdsQueryPatientId patientId,
XdsDocumentQueryOptions
queryOptions);
// Find all the Document references using a Multiple Patient Query Filter.
[OperationContract]
XdsObjectEntryUuid[ ]
FindDocumentsForMultiplePatients(XdsTransactionIdentifier
xdsTransactionIdentifier, XdsMpqPatientIds patientIds,
XdsDocumentQueryOptions
mpqQueryOptions);
// Find all the Folder references for a particular document.
[OperationContract]
XdsObjectEntryUuid[ ] FindFoldersForDocument(XdsTransactionIdentifier
xdsTransactionIdentifier, XdsObjectUniqueId documentUniqueId,
XdsObjectEntryUuid
documentUuid, string homeCommunityId);
// Get all the Document references for a patient. Query options can
be supplied.
[OperationContract]
XdsDocument[ ] GetDocuments(XdsTransactionIdentifier
xdsTransactionIdentifier,
XdsQueryPatientId patientId, XdsDocumentQueryOptions queryOptions);
// Get all the Document references for a patient with Document Metadata
Only. Query
options can be supplied.
[OperationContract]
XdsDocument[ ]
GetDocumentsDocMetaDataOnly(XdsTransactionIdentifier
xdsTransactionIdentifier, XdsQueryPatientId patientId,
XdsDocumentQueryOptions
queryOptions);
// Get a Document using the Unique Id of the folder.
[OperationContract]
XdsDocument GetDocumentUsingUniqueId(XdsTransactionIdentifier
xdsTransactionIdentifier, XdsObjectUniqueId uniqueId, string
homeCommunityId);
// Get a Document using the Entry Uuid of the document. This gets a
specific document.
[OperationContract]
XdsDocument GetDocumentUsingEntryUuid(XdsTransactionIdentifier
xdsTransactionIdentifier, XdsObjectEntryUuid entryUuid, string
homeCommunityId);
// Get a Document using the Unique Id of the document with Document
Metadata Only.
[OperationContract]
XdsDocument
GetDocumentUsingUniqueIdDocMetaDataOnly(XdsTransactionIdentifier
xdsTransactionIdentifier, XdsObjectUniqueId uniqueId, string
homeCommunityId);
// Get the documents for a folder.
[OperationContract]
XdsDocument[ ] GetFolderAndContents(XdsTransactionIdentifier
xdsTransactionIdentifier, XdsObjectEntryUuid folderUniqueId, string
homeCommunityId);
// Get all the folders for a document.
[OperationContract]
XdsFolder[ ] GetFoldersForDocument(XdsTransactionIdentifier
xdsTransactionIdentifier,
XdsObjectUniqueId documentUniqueId, XdsObjectEntryUuid
documentEntryUuid,
string homeCommunityId);
// Get all the related Documents for a document.
[OperationContract]
XdsDocument[ ] GetRelatedDocuments(XdsTransactionIdentifier
xdsTransactionIdentifier, XdsObjectUniqueId documentUniqueId,
AssociationTypes
associationTypes);
// Get the Response of a Query.
[OperationContract]
string GetQueryResponse( );
// Get the Log of a Request.
[OperationContract]
string GetLog( );
// Get the Last Error for a request.
[OperationContract]
string GetLastError( );

Metadata update interface 38 may be used to communicate with a metadata update interface 58 of web service API 50 to maintain registry 74 and permit the modification of the metadata of stored documents. For example, a user may update the metadata values of a stored folder or document through metadata update interface 38. In one embodiment, each request to update the metadata of a stored folder or document is treated as a submission. Accordingly, in this embodiment, the user must identify the submitter of the request. Configuration interface 32 then retrieves the metadata template associated with the author of the submission, which may be edited as desired, from database 62. The user must also identify the document or folder being updated and input the new metadata values or the metadata revisions to be entered. Similarly, a user may change the status of a stored document or folder by identifying the document or folder being updated and inputting the new status (Deprecated, Approved or Submitted).

Metadata update interface 38 may also be used to move documents from one folder to another. In one embodiment, each request to move a document from one folder to another is treated as a submission requiring the user to identify the submitter and include the metadata associated with a submission set. The user must also identify the document to be moved, the folder the document is to be moved from (if applicable) and the new folder the document is to be moved to.

Further, metadata update interface 38 may be used to delete folders or documents. In one embodiment, each deletion request is treated as a submission requiring the user to identify the submitter and include the metadata associated with a submission set. The user must also identify the folder(s) and/or document(s) to be deleted. If a document is being deleted and the document contains multiple versions, the user may be asked whether all versions of the document are to be deleted. Similarly, if a folder is being deleted, the user may be asked to whether all versions of the folder are to be deleted and/or whether any documents contained within the folder are to be deleted too.

Example code for utilizing metadata update interface 38 according to one embodiment includes:

// Update the Metadata of a document.
[OperationContract]
void UpdateDocument(XdsTransactionIdentifier xdsTransactionIdentifier,
XdsLocalPatientIdentifier localPatientIdentifier, XdsSubmissionSet
submissionSet,
XdsDocument newDocument);
// Change the status of a document.
[OperationContract]
void ChangeDocumentStatus(XdsTransactionIdentifier
xdsTransactionIdentifier,
XdsLocalPatientIdentifier localPatientIdentifier, XdsSubmissionSet
submissionSet,
XdsDocument theDocument, DocStatuses newStatus);
// Move document from one folder to another.
[OperationContract]
void MoveDocumentsFolderToFolder(XdsTransactionIdentifier
xdsTransactionIdentifier,
XdsSubmissionSet submissionSet, XdsDocument[ ] theDocuments,
XdsFolder
fromFolder, XdsFolder toFolder);
// Delete a document and optionally all of the versions of that document.
[OperationContract]
void DeleteDocument(XdsTransactionIdentifier xdsTransactionIdentifier,
XdsDocument
theDocument, bool deleteAllVersions);
// Delete a folder and optionally all of its versions and documents
associated with that
folder.
[OperationContract]
void DeleteFolder(XdsTransactionIdentifier xdsTransactionIdentifier,
XdsFolder
theFolder, bool deleteAllVersions, bool deleteFolderDocuments);

The foregoing description illustrates various aspects of the present disclosure. It is not intended to be exhaustive. Rather, it is chosen to illustrate the principles of the present disclosure and its practical application to enable one of ordinary skill in the art to utilize the present disclosure, including its various modifications that naturally follow. All modifications and variations are contemplated within the scope of the present disclosure as determined by the appended claims. Relatively apparent modifications include combining one or more features of various embodiments with features of other embodiments.

What is claimed is:

1. A computing device comprising one or more processing devices configured to receive a request to submit a non-DICOM electronic healthcare document to an electronic repository, to associate a preformed metadata template with the electronic healthcare document, and to send the electronic healthcare document and the associated metadata for submission to the electronic repository and an electronic registry, respectively.

2. The computing device of claim 1, wherein the one or more processing devices are configured to retrieve a metadata template associated with an author submitting the electronic healthcare document and to associate the retrieved metadata template with the electronic healthcare document.

3. The computing device of claim 1, wherein the one or more processing devices are configured to enable a user to edit the preformed metadata template prior to sending the electronic healthcare document for submission to the electronic repository.

4. The computing device of claim 1, wherein the one or more processing devices are configured to receive an identification of the electronic healthcare document to be submitted, an identification of the submitting author and an identification of a patient the electronic healthcare document relates to.

5. The computing device of claim 1, wherein the one or more processing devices are configured to send the electronic healthcare document and the associated metadata to a web service interface for submission to the electronic repository and the electronic registry, respectively.

6. A computer system comprising a web service interface configured to receive a non-DICOM electronic healthcare document and metadata associated with the non-DICOM electronic healthcare document, to convert the electronic healthcare document from an object format of the web service interface to XDS object format, and to submit the converted electronic healthcare document to an electronic repository and the associated metadata to an electronic registry.

7. The computer system of claim 6, wherein the web service interface is configured to provide a call back URL for tracking the submission of the electronic healthcare document.

8. The computer system of claim 6, wherein the web service interface is configured to search electronic healthcare documents stored in the electronic repository.

9. The computer system of claim 8, wherein the web service interface is configured to convert a search request from an object format of the web service interface to XDS object format, to perform the search in the electronic repository based on metadata associated with the electronic healthcare documents stored in the electronic repository, and to convert the search results from XDS object format to the object format of the web service interface.

10. The computer system of claim 9, wherein the web service interface is configured to return the search results in the object format of the web service interface.

11. The computer system of claim 6, wherein the web service interface is configured to edit a preformed metadata template for submission with the non-DICOM electronic healthcare document.

12. The computer system of claim 6, wherein the web service interface is configured to edit metadata associated with a selected electronic healthcare document stored in the electronic repository.

13. The computer system of claim 6, wherein the web service interface is configured to delete a selected electronic healthcare document from the electronic repository.

14. The computer system of claim 6, wherein the web service interface is configured to move a selected electronic healthcare document stored in the electronic repository to a selected folder in the electronic repository.
